(19) United States
(12) Patent Application Publication
(10) Pub. No.: US 2007/0283264 A1
(43) Pub. Date: Dec. 6, 2007

(54) Method Of Display Control Using Portable Equipment With An Image Sensor

(76) Inventors: Jean-Marie Vau, Paris (FR); Eric Masera, Paris (FR); Olivier A. Furon, Dinard (FR); Olivier M. Rigault, La Celle St Cloud (FR); Thierry Lebihen, Bourg La Reine (FR); Christophe E. Papin, Bois Colombes (FR); Nicolas P. Touchard, Suresnes (FR); Olivier L. Seignol, Grenoble (FR)

Correspondence Address: EASTMAN KODAK COMPANY;PATENT LEGAL STAFF, 343 STATE STREET, ROCHESTER, NY, 14650-2201, US

(21) Appl. No.: 11/576,949

(22) PCT Filed: Sep. 28, 2005
(86) PCT No.: PCT/EP05/10456

§ 371 Date: Apr. 10, 2007

(30) Foreign Application Priority Data
Oct. 12, 2004 (FR) 0410717

(51) Int. Cl. G06F 3/00

(52) U.S. Cl. 715/700

(57) ABSTRACT

A method of display control using portable equipment (602) provided with an image sensor including the capture of a series of images; the estimate of the movement made in the displacement of the portable equipment; and the modification of the display according to the movement estimate, according to the invention, in which the movement estimate includes: a) the selection of at least one first (10) and at least one second image; b) the application to the first image of a set of predictive displacements (10d, 10g, 10h, 10b, 10nd, 10bd, 10hg, 10bg); c) the calculation and comparison of the value of at least one characteristic of the first image assigned respectively with each of the predictive displacements with the value of the same characteristic of the second imaged; d) the determination of the predictive displacement (dp) leading to a value of the characteristic, closest to that of the second image; and e) use of the predictive displacement determined in step d as the movement estimate.

### FIELD OF THE INVENTION

The present invention relates to a method of display control using portable equipment provided with an image sensor. Portable equipment means any equipment such as a mobile phone, a photographic camera, a personal organizer, or a computer, provided with a self-contained power supply and that a user can hold in the hand. Portable equipment is generally provided with a display screen. The screen has dimensions that relate to those of the equipment and thus has a small display area. In order to propose improved viewing comfort, the equipment is generally provided with a display mode in which an image to be displayed is not fully displayed, but in parts. More precisely a selected part of the image is displayed enlarged. A control then enables the parts of the image to be displayed to be selected and thus to “navigate” in an image with dimensions greater than the screen. An analog control also enables, if necessary, a pointer to be moved in the image and image parts to be selected, in a similar way to a computer mouse. These controls perform display control in the sense of the invention.

The invention has applications in the improvement of the display control of portable equipment and in their possible use as free control mouse.

### BACKGROUND OF THE INVENTION

The display control of portable equipment is usually performed using a touch pad, or, more modestly, using one or more direction selection buttons—up, down, right or left. These control means, like the display screen, are small because of the portable nature of the equipment. Display control is consequently often difficult or inaccurate.

Documents (1) and (2) whose references are given at the end of the description, propose a display mode enabling navigation in an image using movements of the portable equipment as the control means for display control. The movements of the portable equipment are taken into account, for example, using accelerometers.

The presence of specific movement sensors, like accelerometers, however has the effect of increasing the complexity and cost of portable equipment.

Document (3), whose references are also given at the end of the description, proposes a method of “navigation” in an image, for example navigation in the image of a geographic map, by making use of an image sensor built into the portable equipment. Monitoring of the movement is performed in real-time using images captured by an image sensor. Indeed, movement of the portable equipment, established using captured images, is used to control the display making parts of the image to be displayed appear on the screen.

The movement taken into account is the relative movement between the portable equipment and a predetermined target located in the image sensor's field of view. This target can in particular be part of the user's body, for example their head, or part of their clothes.

### SUMMARY OF THE INVENTION

The invention results from the identification of a number of difficulties liable to appear in the implementation of the methods described above, and especially in the implementation of a navigation method using the monitoring of a target.

A first difficulty consists in implementing the method on portable phonecams provided with an image sensor. In general these devices have a display screen located opposite the image sensor. It is therefore difficult to monitor a target attached to the user while letting them view the display screen.

Another difficulty relates to the identification of the target and the risk of “loosing” the target, when the user tilts the portable equipment. Indeed loss of the target occurs when the size of the movement given to the portable equipment by the user means that the identified target leaves the image sensor's field of view.

Yet another difficulty relates to target recognition. If the target is not recognized or identified, monitoring it is clearly not possible.

It is the object of the invention to propose a method of display control using portable equipment, provided with an image sensor, in which the difficulties mentioned above are overcome. In particular, one object of the invention is to propose such a method in which the estimation of the movement is freed from monitoring a target.

Yet another object is to propose a control method that is robust and not very sensitive to the interference variations of light, movement or iconic content, capable of affecting images captured by the sensor for estimating the movement.

To achieve these objects, the invention has more precisely for object a method of display control using portable equipment provided with an image sensor, comprising:

the capture of a series of images in a capture mode inviting the user to displace the portable equipment,

the movement estimate made in the displacement of the portable equipment, and

the modification of the display according to the movement estimate.

According to the invention, the movement estimate comprises:

a) the selection of at least one first and at least one second image of the image series, the second image being captured later than the first image,

b) the application to the first image of a set of predictive displacements corresponding to various displacement directions,

c) the calculation and comparison of the value of at least one characteristic of the first image assigned respectively with each of the predictive displacements with the value of the same characteristic of the second image, and

d) the determination of the predictive displacement leading to a value of the characteristic, closest to that of the second image,

e) the selection of the predictive displacement determined in step d as the movement estimate.

While a movement estimate can take place with only two captured images, the method is preferably implemented continuously by using a series of first images and a series of second images, later, one to one, respectively with the first images. When the calculation capacity of the portable equipment is sufficient an implementation can be envisioned in which each captured image is used as “second image” in relation to the previous image and as “first image” in relation to the next image of the image flow. A more restricted sampling of images may also be appropriate.

Using the invention, the movement estimate can be achieved without using a target and without risk of faulty target identification or risk of target “loss”. In addition, the method can be implemented both with portable equipment whose image sensor is on the same side as the control screen, and with portable equipment for which the sensor is located on a side opposite that bearing the screen. The latter case is the most frequent for phonecams.

The determination of the predictive displacements, the calculation of the characteristics of the first images assigned with displacements, and the calculation of the characteristics of the second images can be performed using all the pixels of the first and second images. To reduce the calculation capacity required, it is also possible to perform these operations on a smaller number of pixels. It is possible to select only a calculation frame of one pixel out of five or one pixel out of ten.

The same applies to the predictive displacements. The predictive displacements can be performed for a large number of directions and with a large number of amplitudes. However, this requires considerable calculation capacity. Reduced calculation capacity is sufficient if the predictive displacements take place only in a reduced subset of directions and a reduced subset of amplitudes. For example it is possible to limit the predictive displacements to eight directions distributed in an isotropic way, in 45° steps. For each displacement, it is possible to test only a reduced number of displacement amplitudes, in steps of 5, 10 or 20 pixels. A predictive displacement with a single amplitude can also be envisioned.

The most relevant predictive displacement is that which best conveys the movement of the portable equipment between the capture of the first and second image. Finding this predictive displacement takes place by comparing, for each predictive displacement, the value of a characteristic of the first image assigned with the displacement and the value of the same characteristic of the second image. For example this is one characteristic selected from among a local light intensity, a sum of light intensities, a combination of light intensities, a color or a combination of colors, a local spatial frequency or a combination of local spatial frequencies. As described above, the value of these characteristics can be calculated for all the pixels of the images or for a subset of pixels only.

According to a particular implementation of the method, the characteristic taken into account is a light intensity. Steps c) and d) of the method can then comprise finding an overall minimum of a similarity function with the form:

$$D ( dP ) = {\sum }_{p} {( {I}_{1} ( p + dp ) - {I}_{2} ( p ) )}^{2}$$

where dp is a vector of predictive displacement between the first and second image and in which a sum is made on a set of predetermined pixels p of the first and second image, in which I₁(p+dp) and I₂(p) indicate a value of intensity in the first image of a pixel offset by dp in relation to a pixel p, and the value of intensity in the second image of the pixel p respectively. In step d) of the method, the predictive displacement dp is determined for which the function D is a minimum. The predictive displacement dp leading to the minimum of the function D is taken as the most relevant. It is used to estimate the movement and modify the display. The sum of the squared differences, suggested above, can be replaced, for example, by the sum of the absolute values of the differences or again, more generally, by a correlation function. The displacement dp can be constant, or can be modeled using a parametric model whose number of parameters used enables more or less complex movements to be taken into account. In particular, a zoom can be characterized by using a refined model with 4 or 6 parameters.

The sum on p is performed either for all the image pixels or for a subset of image pixels.

In particular, the function D can be calculated for a predetermined limited number of pixels that are not touching and distributed in the frame of the first image, preferably in a central region.

The minimum of the function D indicates the most relevant predictive displacement dp. The value of the minimum can also, in the case of an uneven scene, give an indication of the degree of relevance of the prediction.

Thus, according to a particular aspect of the invention, the minimum value of the function D is compared with a threshold value and the user warned when the minimum value of the function D is greater than the threshold value. In this case, it may be possible, not to take account of the estimated movement to modify the display.

Indeed, when the minimum value of D is high, i.e. greater than the threshold, this means that none of the first images assigned with a predictive displacement is close to the characteristics of the second image. The user, warned in this way, can then repeat their control by giving a new displacement movement to the portable equipment. The movement estimate can also be repeated using the same pair of images by using, for example, a more complex movement model, for example a parametric model, better suited to characterize the time change.

In order to compensate for any erratic movements, the modification of the display need not take into account the individual movement estimates made using each pair of first and second images, but using a more overall estimate. For example, it is possible to establish a series of individual movement estimates using the series of captured images, and then calculate an overall movement estimate by filtering the individual estimates.

For example, the filtering is Kalman type, taking into account one component linked to each new individual movement estimate, and one or more components linked to the previous estimates respectively.

Other characteristics and advantages of the invention will appear in the following description, with reference to the figures in the appended drawings. This description is given purely as an illustration and is not limiting.

### BRIEF DESCRIPTION OF THE DRAWINGS

FIG. 1 represents a first and second image respectively of a series of captured images, used to control the display.

FIG. 2 represents the first image of FIG. 1 and a set of images illustrating a set of predictive displacements.

FIG. 3 illustrates a movement estimate made using a set of images of a series of images.

FIG. 4 is a diagram showing the main steps of a method according to the invention.

### DETAILED DESCRIPTION OF THE INVENTION

In the following description, for simplification purposes, and to show better the movement given by the user to the portable equipment, an identical subject, in this case a face V, is represented in each of the images. However, it should be noted that the face V is not a target. The calculations performed to establish the predictive replacements and compare the images are carried out separately from any particular iconic content. Here it is simply to facilitate the reading of the drawings.

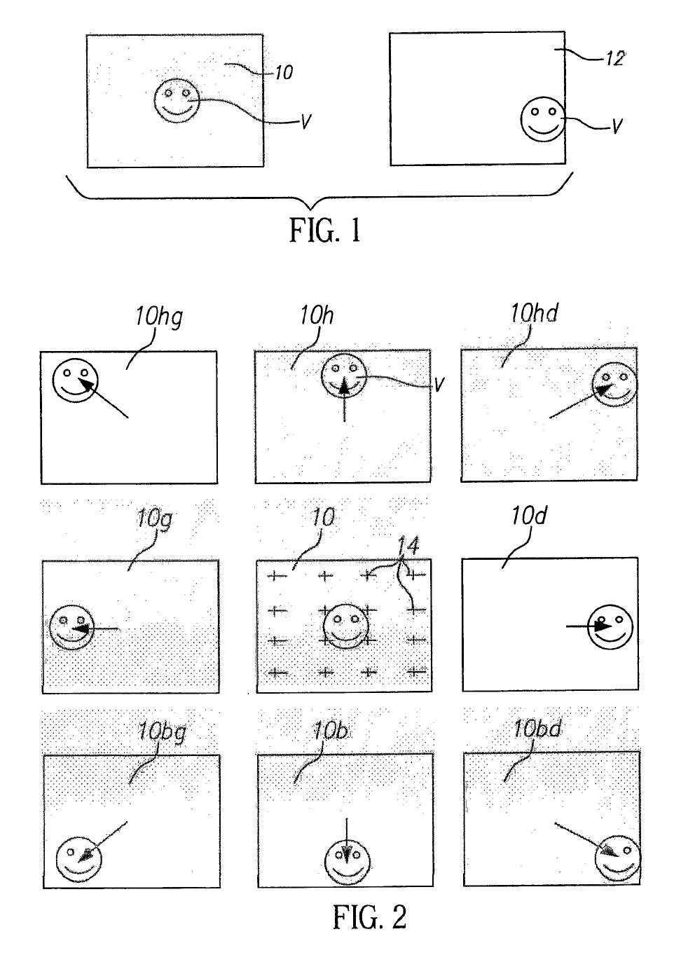

FIG. 1 shows a first image 10 and a second image 12 captured after the first image 10. Between the images 10 and 12, the user gave the portable equipment a movement to the left and slightly upwards. This is illustrated by the fact that the face is displaced within the image frame to the right and slightly downwards.

The first image 10 is also represented in the central part of FIG. 2. A number of predictive displacements are applied to this image. The predictive displacements can be applied to all the pixels of the image 10 or to a subset of pixels 14. For example, the subset of pixels is one pixel, taken out of five or ten. It is distributed in the image more or less evenly. Calculating the predictive displacements for the subset of pixels has the effect of reducing the calculation capacity required and/or reducing the calculation time. The predictive displacements are limited to a number of preferred directions. In the illustrated example, eight directions are selected, up, down, right, left, and directions in between the previous at 45°. They are represented by eight predictive images 10d, 10g, 10h, 10b, 10hd, 10hg, 10bd, 10bg. The predictive displacements are also shown by arrows.

In the illustrated example, all the predictive displacements have the same amplitude. However, it is possible to allow for several predictive displacements with different amplitudes in each direction. Many predictive displacements with amplitudes varying by 20-pixel steps for example can be envisioned. Also in this case, the predictive displacements can be established for all the image pixels or for a pixel subset, as described above. This amounts to performing the calculations for an image with lower resolution.

Among all the predictive displacements established using the first image, the one that leads to an image most similar to the second image is selected.

The most similar predictive image can be selected according to one or more image characteristics. For example, this is the light and/or color intensity and/or spatial frequencies of the images. The image characteristics can be taken into account especially in a constraint function where a minimum is looked for; the minimum being reached by the predictive image nearest the second image.

In the case of the example illustrated by FIGS. 1 and 2, the predictive image nearest the second image 12 is predictive image 10d located to the right of the central image. The predictive displacement that led to predictive image 10d is a displacement of the pixels to the right. This corresponds to a displacement of the portable equipment to the left. The displacement to the right is then used as an indicator of estimated movement and used to modify the display of the portable equipment.

According to whether the movement estimate is used for the displacement of a pointer in the image or for navigation in a virtual image with dimensions greater than those of the display screen, the movement applied to the display or to the pointer can be reversed or not in relation to that of the estimated displacement.

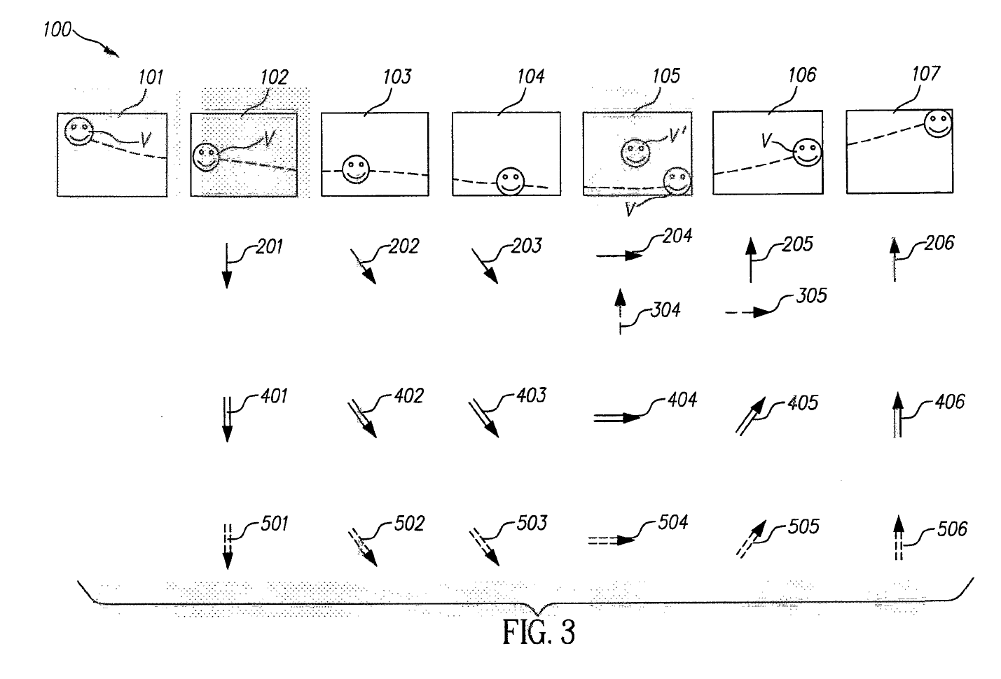

FIG. 3 shows a series of images 100 captured by a shot sensor of the portable equipment. The images have references from 101 to 107. They all show the face V that enables the movement of the portable equipment to be shown more easily. The presence of the face, besides aiding the clarity of the figures, has no particular role.

Each of the images, except for the first and last, can constitute both a first and second image according to the invention. For example, the image 102 constitutes a “second image” in a movement estimate made in relation to the image 101 selected as “first image”. Resulting from this is a movement estimate according to an arrow 201 pointing downwards.

The same image 201 can also constitutes a “first image” in a movement estimate made in relation to the image 103 selected as “second image”. Resulting from this is a movement estimate according to an arrow 202 pointing downwards and to the right at 45°.

By using in turn each of the images of the image series 100 as a first and as a second image, a set of estimated movement indicators is established. These are represented as solid arrows referenced from 201 to 206. According to an improvement, the estimated movement indicators can also provide information on a movement amplitude between two successive images when they result from predictive displacements of variable amplitude.

The estimated movement indicators can be used as such to modify the display. However, a filtering can be applied to them to obtain an overall variable movement estimate. In particular this amounts to erasing the effect of the sudden movements given to the portable equipment and thus preventing sudden modifications of the display. For example, the filtering amounts to performing a weighted average between one movement estimate and the nearest previous estimate(s). According to another option, the filtering can be planned to prevent a rotation of more than 45° of a movement indicator with the next, and to take into account the indicator of the immediately previous estimate.

In the example of FIG. 3, a large change of the movement estimate takes place for the indicators 204, to the right, and the indicator 205 upwards. Thus the indicator 205, upwards, can be attenuated by replacing it with an indicator 405 upwards and to the right at 45°. The overall movement estimate after filtering is illustrated by the double arrows 401 to 406, which correspond to new indicators that can be used to modify the display.

Filtering also has the effect of erasing uncontrolled movements of the portable equipment or any local errors of the movement estimate. The image 105 of FIG. 3 provides an example. It may be imagined that the estimated movement is, accidentally or by error, that corresponding to the face V′ with a broken line, instead of that corresponding to the face V with a solid line.

Thus the movement indicators 204 and 205 pointing to the right, then upwards respectively, would be replaced by the indicators 304 and 305 pointing upwards then to the right respectively.

By performing a filtering that takes into account the immediately previous estimate, and that prevents a rotation of more than 45° of the indicators, the series of indicators represented by the double arrows in broken line 501 to 506 is obtained. These new indicators are obtained, after filtering, using the indicators 201, 202, 203, 304, 305 and 206.

It may be observed that the indicators 401 to 406 are the same as the indicators 501 to 506. This means that a one-off error of movement estimate, or an unwanted movement of the portable equipment can be attenuated, or completely deleted by the filtering of the movement estimates.

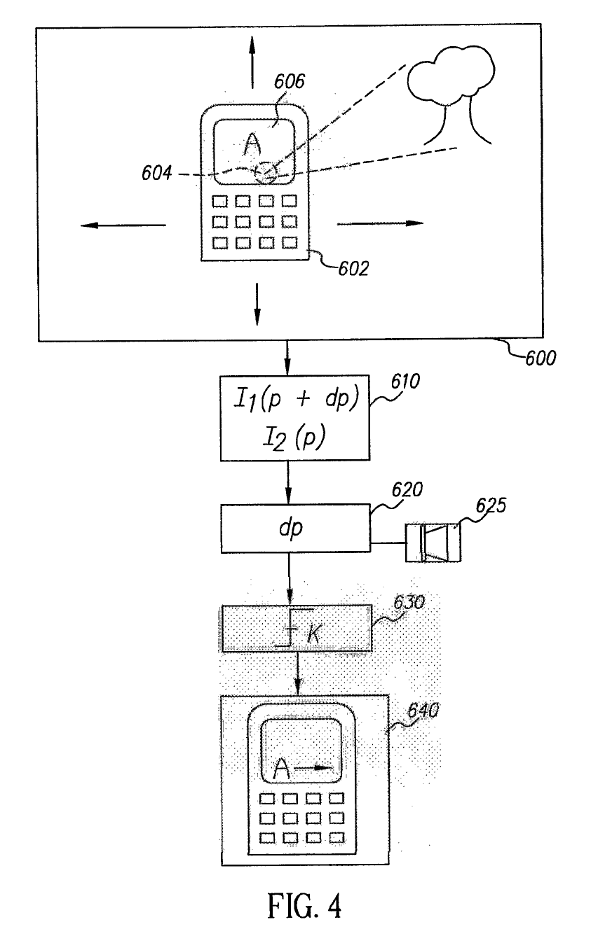

FIG. 4 shows one implementation option of the invention method as a flow chart.

The reference 600 corresponds to image capture in a capture mode in which a mobile phone 602 is used as display control means. The telephone 602 here represents a class of portable equipment provided with an image sensor. Images are captured by the image sensor 604, shown with a broken line, and located on one side of the mobile phone 602, opposite the visible side that bears a control screen 606.

It may be noted that none of the image(s) displayed on the screen 606 are those captured by the sensor. The images captured by the sensor have the sole function of estimating the movement that the user imparts to the mobile phone 602.

All or part of the captured images are selected as “first” and/or “second” image, in the way previously described. This step corresponds to the reference 610. The first images are assigned with predictive displacements and compared with the “second images”.

There results a movement estimate 620, performed by taking the predictive displacement that gives the best correspondence between the first and second images considered. When the correspondence is too poor, the movement estimate is not taken into account to control the display, and a warning 625 is given to the user. This is the case, for example, when the minimum of a correlation function is greater than a predetermined value.

The selection of the first and second images and the movement estimate are here continually repeated operations, along with the acquisition of the images.

Then a filtering operation occurs 630, which, as previously described, enables errors of the movement estimate and erratic movements to be corrected or attenuated.

Finally, the reference 640 indicates the modification of the display according to the movement estimate. The modification of the display can take place on the screen 606 of the mobile phone as shown in the figure. It can also take place on another screen, separate from the phone, and for which the mobile phone is simply used as the display control means.

### CITED DOCUMENTS

(1) U.S. Pat. No. 6,466,198
(2) WO 02/093331
(3) WO 00/75914

1) A method of display control using portable equipment provided with an image sensor comprising:
capturing a series of images in a capture mode inviting the user to displace the portable equipment,
estimating the movement made whilst the displacement of the portable equipment, and
modifying the display according to the movement estimate,
characterized in that the movement estimate comprises:
a) selecting at least one first and at least one second image of the image series, the second image being captured later than the first image,
b) applying to the first image a set of predictive displacements corresponding to various displacement directions,
c) calculating and comparing the value of at least one characteristic of the first image assigned respectively with each of the predictive displacements with the value of the same characteristic of the second image, and
d) determining the predictive displacement (dp) leading to a value of the characteristic, closest to that of the second image,
e) using the predictive displacement determined in step d as the movement estimate.

2) A method according to claim 1, wherein the predictive displacements and the calculation of the values of the characteristics of the first displaced images and the second image are performed for a subset of pixels.

3) A method according to claim 1, wherein the characteristic is selected from among a light intensity, a sum of local light intensities, a combination of local light intensities, a color or a combination of colors, a local spatial frequency or a combination of local spatial frequencies.

4) A method according to claim 3, wherein the characteristic is a light intensity and wherein the steps c) and d) include the search for a minimum of a function D with the following form:
$$D ( dp ) = {\sum }_{p} {( {I}_{1} ( p + dp ) - {I}_{2} ( p ) )}^{2}$$
in which a sum is made on a predetermined set of pixels (p) of the first and second image, in which I₁(p+dp) and I₂(p) indicate a value of intensity in the first image of a pixel offset by dp in relation to a pixel p, and the value of intensity in the second image of the pixel p,
and wherein, in step d), the predictive displacement is determined for which the function D is a minimum.

5) A method according to claim 4, wherein the calculation of the function D is performed for a predetermined limited number of pixels that are not touching and distributed in the frame of the first image.

6) A method according to claim 4, wherein the minimum of the function D is compared with a threshold value and wherein the user is warned when the minimum of the function D is greater than the threshold value.

7) A method according to claim 1, wherein the steps a) to e) are iterated by using each new image of the sequence as a second image in relation to the previous image, and as a first image in relation to the next image.

8) A method according to claim 1, wherein a series of individual movement estimates is established using the series of captured images, and wherein an overall variable movement estimate is calculated by filtering the individual estimates.

9) A method according to claim 8, wherein a filtering of the Kalman type is performed.
